(19) United States
(12) Patent Application Publication
(10) Pub. No.: US 2020/0234874 A1
(43) Pub. Date: Jul. 23, 2020

(54) MULTILAYER COIL COMPONENT

(71) Applicant: TDK CORPORATION, Tokyo (JP)

(72) Inventors: Hajime KATO, Tokyo (JP); Hidekazu SATO, Tokyo (JP); Makoto YOSHINO, Tokyo (JP); Kazuya TOBITA, Tokyo (JP); Yuto SHIGA, Tokyo (JP); Youichi KAZUTA, Tokyo (JP); Noriaki HAMACHI, Tokyo (JP)

(73) Assignee: TDK CORPORATION, Tokyo (JP)

(21) Appl. No.: 16/746,276

(22) Filed: Jan. 17, 2020

(30) Foreign Application Priority Data
Jan. 23, 2019 (JP) 2019-009396

(51) Int. Cl. H01F 27/29; H01F 27/28

(52) U.S. Cl. CPC H01F 27/292; H01F 2027/2809; H01F 27/2804

(57) ABSTRACT

A multilayer coil component 1 includes four terminal electrodes 3, 4, 5, and 6. A part of the coil 8 as viewed from the facing direction of a pair of main surfaces 2c and 2d is disposed in at least one of first and second regions A1 and A2 formed between the pair of terminal electrodes 3 and 4 and the pair of terminal electrodes 5 and 6 disposed so as to face each other in the facing direction of the pair of side surfaces 2e and 2f and third and fourth regions formed between the pair of terminal electrodes 3 and 5 and the pair of terminal electrodes 4 and 6 disposed so as to face each other in the facing direction of the pair of end surfaces 2a and 2b.

### TECHNICAL FIELD

One aspect of the present invention relates to a multilayer coil component.

### BACKGROUND

The multilayer coil component described in, for example, Patent Literature 1 (Japanese Unexamined Patent Publication No. H11-214235) is known as a multilayer coil component according to the related art. The multilayer coil component described in Patent Literature 1 is provided with an element body, a coil disposed in the element body, and a pair of terminal electrodes embedded in the element body and disposed so as to be separated from each other in the facing direction of a pair of end surfaces of the element body.

### SUMMARY

The multilayer coil component can be reduced in size in a configuration in which the terminal electrode is embedded in the element body as in the multilayer coil component according to the related art. However, when the terminal electrode is disposed in the element body, the region in the element body decreases, and thus the inner diameter of the coil cannot be increased. In addition, an increase in the inner diameter of the coil results in a decrease in the distance between the terminal electrode and the coil in the multilayer coil component according to the related art. Then, problems arise as the stray capacitance (parasitic capacitance) formed by the coil and the terminal electrode increases and characteristics deteriorate.

An object of one aspect of the present invention is to provide a multilayer coil component in which characteristics can be improved.

A multilayer coil component according to one aspect of the present invention includes an element body including a pair of end surfaces facing each other, a pair of main surfaces facing each other, and a pair of side surfaces facing each other, one of the main surfaces being a mounting surface, a coil disposed in the element body and having a coil axis extending along a facing direction of the pair of main surfaces, and four terminal electrodes embedded in the element body and respectively disposed in four corner portions of the element body respectively formed by the pair of end surfaces and the pair of side surfaces. Each of the four terminal electrodes is disposed over at least the end surface, the mounting surface, and the side surface. A part of the coil as viewed from the facing direction of the pair of main surfaces is disposed in at least one of first and second regions formed between the pair of terminal electrodes disposed so as to face each other in a facing direction of the pair of side surfaces and third and fourth regions formed between the pair of terminal electrodes disposed so as to face each other in a facing direction of the pair of end surfaces.

In the multilayer coil component according to one aspect of the present invention, each of the four terminal electrodes is embedded in the element body. Accordingly, the four terminal electrodes fit within the outer shape of the element body and do not protrude from the outer surface of the element body. Accordingly, the multilayer coil component can be reduced in size. In this configuration, in the multilayer coil component, a part of the coil is disposed in at least one of the first and second regions and the third and fourth regions. In this manner, in the multilayer coil component, a part of the coil is disposed in the region between the pair of terminal electrodes disposed so as to face each other. Accordingly, in the multilayer coil component, the inner diameter of the coil can be increased, and thus the Q value can be improved. Accordingly, characteristics can be improved in the multilayer coil component. In addition, in the multilayer coil component, the distance between the coil and the terminal electrode can be ensured even in a case where the inner diameter of the coil is increased. Accordingly, in the multilayer coil component, the stray capacitance that is generated between the terminal electrode and the coil can be reduced. As a result, characteristics can be improved in the multilayer coil component.

In the multilayer coil component, each of the four terminal electrodes is disposed over at least the end surface, the mounting surface, and the side surface. When the multilayer coil component is mounted on a circuit board or the like in this configuration, solder is formed at the parts that correspond to the end surface, the mounting surface, and the side surface in each of the four terminal electrodes. Accordingly, the multilayer coil component and the circuit board can be firmly fixed. In addition, in the multilayer coil component, it can be visually confirmed that the solder is reliably formed since the solder is formed at the parts that correspond to the end surface and the side surface in each of the four terminal electrodes.

In one embodiment, a first dimension of the element body in the facing direction of the pair of end surfaces may be larger than a second dimension of the element body in the facing direction of the pair of side surfaces and a part of the coil may be disposed in at least the first region and the second region. In this configuration, the inner diameter of the coil can be maximized in the coil disposed in the element body having a rectangular parallelepiped shape. Accordingly, characteristics can be further improved in the multilayer coil component.

In one embodiment, a dimension in the facing direction of the pair of end surfaces may be larger than a dimension in the facing direction of the pair of side surfaces in each of the four terminal electrodes. In this configuration, the first region and the second region can be enlarged in the facing direction of the pair of side surfaces. Accordingly, in the multilayer coil component, it is possible to ensure the distance between the coil and the terminal electrode while increasing the inner diameter of the coil. As a result, characteristics can be further improved in the multilayer coil component.

In one embodiment, the multilayer coil component may further include a connecting electrode interconnecting the pair of terminal electrodes disposed so as to face each other in the facing direction of the pair of side surfaces and disposed on the mounting surface. When the multilayer coil component is mounted on a circuit board or the like in this configuration, the multilayer coil component and the circuit board can be more firmly fixed.

Characteristics can be improved according to one aspect of the present invention.

### BRIEF DESCRIPTION OF THE DRAWINGS

FIG. 1 is a perspective view illustrating a multilayer coil component according to a first embodiment.

FIG. 2 is an exploded perspective view illustrating the configuration of an element body and a coil conductor of the multilayer coil component illustrated in FIG. 1.

FIG. 3 is a diagram illustrating the configuration of a terminal electrode and a coil.

FIG. 4 is a diagram illustrating the configuration of the terminal electrode and the coil.

FIG. 5 is a diagram illustrating the configuration of the terminal electrode and the coil.

FIG. 6 is a perspective view illustrating a multilayer coil component according to a second embodiment.

FIG. 7 is an exploded perspective view illustrating the configuration of an element body and a coil conductor of the multilayer coil component illustrated in FIG. 6.

FIG. 8 is a diagram illustrating a terminal electrode and a coil of a multilayer coil component according to another embodiment.

### DETAILED DESCRIPTION

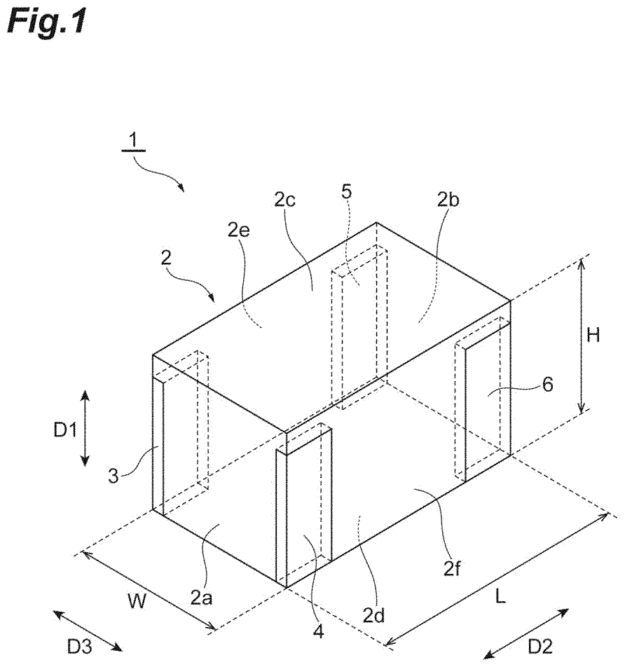

Hereinafter, preferred embodiments of the present invention will be described in detail with reference to the accompanying drawings. In the description of the drawings, the same or equivalent elements will be denoted by the same reference numerals, and redundant description will be omitted.

[First Embodiment] As illustrated in FIG. 1, a multilayer coil component 1 is provided with an element body 2 having a rectangular parallelepiped shape and terminal electrodes 3, 4, 5, and 6. The four terminal electrodes 3, 4, 5, and 6 are respectively disposed in the corner portions of the element body 2. The rectangular parallelepiped shape includes a rectangular parallelepiped shape in which a corner portion and a ridge line portion are chamfered and a rectangular parallelepiped shape in which a corner portion and a ridge line portion are rounded.

The element body 2 has a pair of end surfaces 2a and 2b facing each other, a pair of main surfaces 2c and 2d facing each other, and a pair of side surfaces 2e and 2f facing each other. The facing direction in which the pair of main surfaces 2c and 2d face each other, that is, the direction that is parallel to the end surfaces 2a and 2b is a first direction D1. The facing direction in which the pair of end surfaces 2a and 2b face each other, that is, the direction that is parallel to the main surfaces 2c and 2d is a second direction D2. The facing direction in which the pair of side surfaces 2e and 2f face each other is a third direction D3. In the present embodiment, the first direction D1 is the height direction of the element body 2. The second direction D2 is the longitudinal direction of the element body 2 and is orthogonal to the first direction D1. The third direction D3 is the width direction of the element body 2 and is orthogonal to the first direction D1 and the second direction D2.

A length dimension (first dimension) L of the element body 2 along the second direction D2 is larger than a width dimension (second dimension) W of the element body 2 along the third direction D3 (L>W). The length dimension L of the element body 2 is larger than a height dimension H of the element body 2 along the first direction D1 (L>W). The width dimension W of the element body 2 may be equal to or different from the height dimension H. In the present embodiment, the dimensions of the element body 2 respectively correspond to the dimensions of the multilayer coil component 1.

The pair of end surfaces 2a and 2b extend in the first direction D1 so as to interconnect the pair of main surfaces 2c and 2d. The pair of end surfaces 2a and 2b also extend in the third direction D3, that is, the short side direction of the pair of main surfaces 2c and 2d. The pair of side surfaces 2e and 2f extend in the first direction D1 so as to interconnect the pair of main surfaces 2c and 2d. The pair of side surfaces 2e and 2f also extend in the second direction D2, that is, the long side direction of the pair of end surfaces 2a and 2b. The multilayer coil component 1 is, for example, solder-mounted on an electronic device (such as a circuit board and an electronic component). In the multilayer coil component 1, the main surface 2d constitutes a mounting surface facing the electronic device.

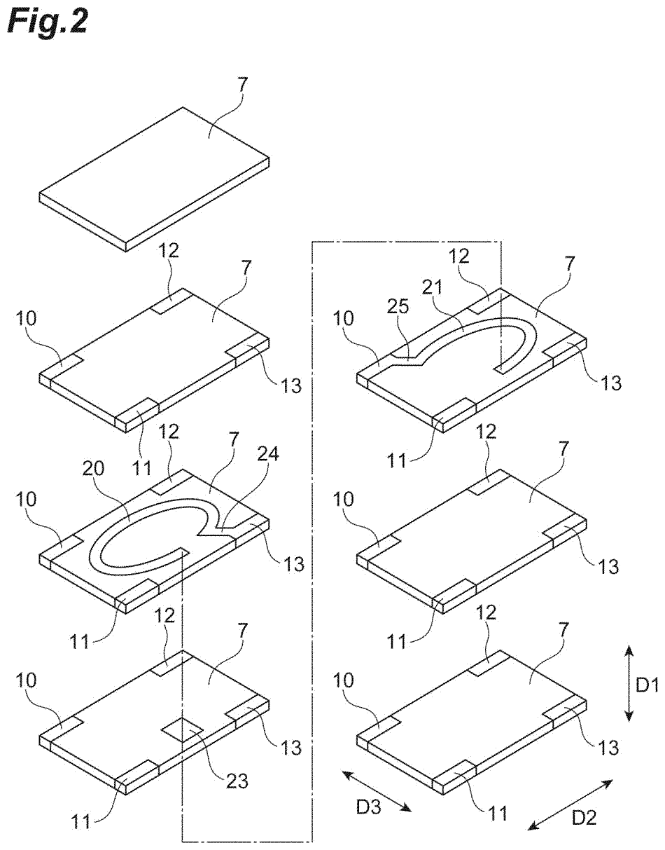

As illustrated in FIG. 2, the element body 2 is configured by a plurality of insulator layers 7 being stacked in the third direction D3. The element body 2 has the plurality of insulator layers 7 that are stacked. In the element body 2, the direction in which the plurality of insulator layers 7 are stacked coincides with the first direction D1. In the actual element body 2, each insulator layer 7 is integrated to the extent that the boundaries between the insulator layers 7 are invisible. Each insulator layer 7 is made of, for example, a magnetic material. Examples of the magnetic material include a Ni—Cu—Zn-based ferrite material, a Ni—Cu—Zn—Mg-based ferrite material, and a Ni—Cu-based ferrite material. The magnetic material constituting each insulator layer 7 may contain a Fe alloy. Each insulator layer 7 may be made of a nonmagnetic material. Examples of the nonmagnetic material include a glass ceramic material and a dielectric material. In the present embodiment, a sintered body of a green sheet containing a magnetic material constitutes each insulator layer 7.

The terminal electrode 3 is disposed on the end surface 2a side of the element body 2. The terminal electrode 3 is disposed in the corner portion that is formed by the end surface 2a and the side surface 2e in the element body 2. The terminal electrode 4 is disposed on the end surface 2a side of the element body 2. The terminal electrode 4 is disposed in the corner portion that is formed by the end surface 2a and the side surface 2f in the element body 2. The terminal electrode 5 is disposed on the end surface 2b side of the element body 2. The terminal electrode 5 is disposed in the corner portion that is formed by the end surface 2b and the side surface 2e in the element body 2. The terminal electrode 6 is disposed on the end surface 2b side of the element body 2. The terminal electrode 6 is disposed in the corner portion that is formed by the end surface 2b and the side surface 2f in the element body 2.

The terminal electrode 3 and the terminal electrode 4 are separated from each other in the third direction D3 and are disposed so as to face each other. The terminal electrode 5 and the terminal electrode 6 are separated from each other in the third direction D3 and are disposed so as to face each other. The terminal electrode 3 and the terminal electrode 5 are separated from each other in the second direction D2 and are disposed so as to face each other. The terminal electrode 4 and the terminal electrode 6 are separated from each other in the second direction D2 and are disposed so as to face each other.

Each of the terminal electrodes 3, 4, 5, and 6 is embedded in the element body 2. Each of the terminal electrodes 3, 4, 5, and 6 is disposed in a recessed portion formed in the element body 2. The terminal electrode 3 is disposed over the end surface 2a, the main surface 2d, and the side surface 2e. The terminal electrode 4 is disposed over the end surface 2a, the main surface 2d, and the side surface 2f. The terminal electrode 5 is disposed over the end surface 2b, the main surface 2d, and the side surface 2e. The terminal electrode 6 is disposed over the end surface 2b, the main surface 2d, and the side surface 2f. In the present embodiment, the surface of the terminal electrode 3 is substantially flush with each of the end surface 2a, the main surface 2d, and the side surface 2e. The surface of the terminal electrode 4 is substantially flush with each of the end surface 2a, the main surface 2d, and the side surface 2f. The surface of the terminal electrode 5 is substantially flush with each of the end surface 2b, the main surface 2d, and the side surface 2e. The surface of the terminal electrode 6 is substantially flush with each of the end surface 2b, the main surface 2d, and the side surface 2f.

Each of the terminal electrodes 3, 4, 5, and 6 contains a conductive material. The conductive material contains, for example, Ag or Pd. Each of the terminal electrodes 3, 4, 5, and 6 is configured as a sintered body of conductive paste containing conductive material powder. Examples of the conductive material powder include Ag powder and Pd powder. A plating layer may be formed on the surface of each of the terminal electrodes 3, 4, 5, and 6. The plating layer is formed by, for example, electroplating or electroless plating. The plating layer contains, for example, Ni, Sn, or Au.

The terminal electrode 3 has a rectangular parallelepiped shape. As illustrated in FIG. 2, the terminal electrode 3 is configured by a plurality of electrode layers 10 being stacked. In the present embodiment, the number of the electrode layers 10 is “6”. The electrode layer 10 has a rectangular shape when viewed from the first direction D1. Each of the electrode layers 10 is provided in a defect portion formed in the insulator layer 7 that corresponds. The electrode layer 10 is formed by conductive paste positioned in a defect portion formed in a green sheet being fired. The green sheet and the conductive paste are fired at the same time. Accordingly, the electrode layer 10 is obtained from the conductive paste when the insulator layer 7 is obtained from the green sheet. In the actual terminal electrode 3, each of the electrode layers 10 is integrated to the extent that the boundaries between the electrode layers 10 are invisible. The recessed portion of the element body 2 that is fired, in which the terminal electrode 3 is disposed, is obtained by the defect portion formed in the green sheet.

As illustrated in FIG. 1, the terminal electrode 4 has a rectangular parallelepiped shape. As illustrated in FIG. 2, the terminal electrode 4 is configured by a plurality of electrode layers 11 being stacked. In the present embodiment, the number of the electrode layers 11 is “6”. The electrode layer 11 has a rectangular shape when viewed from the first direction D1. Each of the electrode layers 11 is provided in a defect portion formed in the insulator layer 7 that corresponds. The electrode layer 11 is formed by conductive paste positioned in a defect portion formed in a green sheet being fired. The green sheet and the conductive paste are fired at the same time. Accordingly, the electrode layer 11 is obtained from the conductive paste when the insulator layer 7 is obtained from the green sheet. In the actual terminal electrode 4, each of the electrode layers 11 is integrated to the extent that the boundaries between the electrode layers 11 are invisible. The recessed portion of the element body 2 that is fired, in which the terminal electrode 4 is disposed, is obtained by the defect portion formed in the green sheet.

As illustrated in FIG. 1, the terminal electrode 5 has a rectangular parallelepiped shape. As illustrated in FIG. 2, the terminal electrode 5 is configured by a plurality of electrode layers 12 being stacked. In the present embodiment, the number of the electrode layers 12 is “6”. The electrode layer 12 has a rectangular shape when viewed from the first direction D1. Each of the electrode layers 12 is provided in a defect portion formed in the insulator layer 7 that corresponds. The electrode layer 12 is formed by conductive paste positioned in a defect portion formed in a green sheet being fired. The green sheet and the conductive paste are fired at the same time.

Accordingly, the electrode layer 12 is obtained from the conductive paste when the insulator layer 7 is obtained from the green sheet. In the actual terminal electrode 5, each of the electrode layers 12 is integrated to the extent that the boundaries between the electrode layers 12 are invisible. The recessed portion of the element body 2 that is fired, in which the terminal electrode 5 is disposed, is obtained by the defect portion formed in the green sheet.

As illustrated in FIG. 1, the terminal electrode 6 has a rectangular parallelepiped shape. As illustrated in FIG. 2, the terminal electrode 6 is configured by a plurality of electrode layers 13 being stacked. In the present embodiment, the number of the electrode layers 13 is “6”. The electrode layer 13 has a rectangular shape when viewed from the first direction D1. Each of the electrode layers 13 is provided in a defect portion formed in the insulator layer 7 that corresponds. The electrode layer 13 is formed by conductive paste positioned in a defect portion formed in a green sheet being fired. The green sheet and the conductive paste are fired at the same time. Accordingly, the electrode layer 13 is obtained from the conductive paste when the insulator layer 7 is obtained from the green sheet. In the actual terminal electrode 6, each of the electrode layers 13 is integrated to the extent that the boundaries between the electrode layers 13 are invisible. The recessed portion of the element body 2 that is fired, in which the terminal electrode 6 is disposed, is obtained by the defect portion formed in the green sheet.

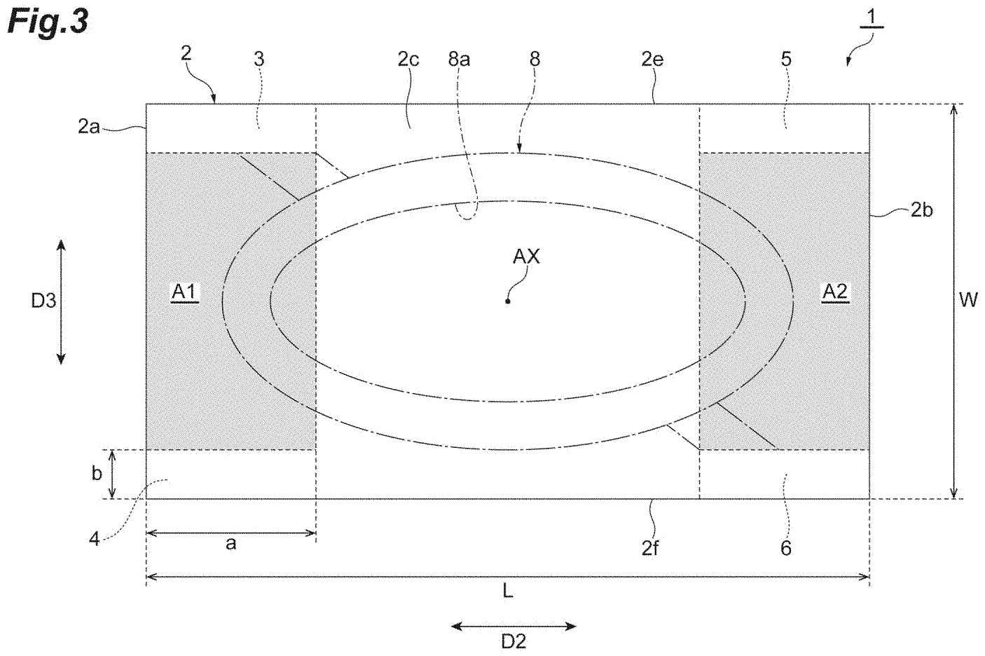

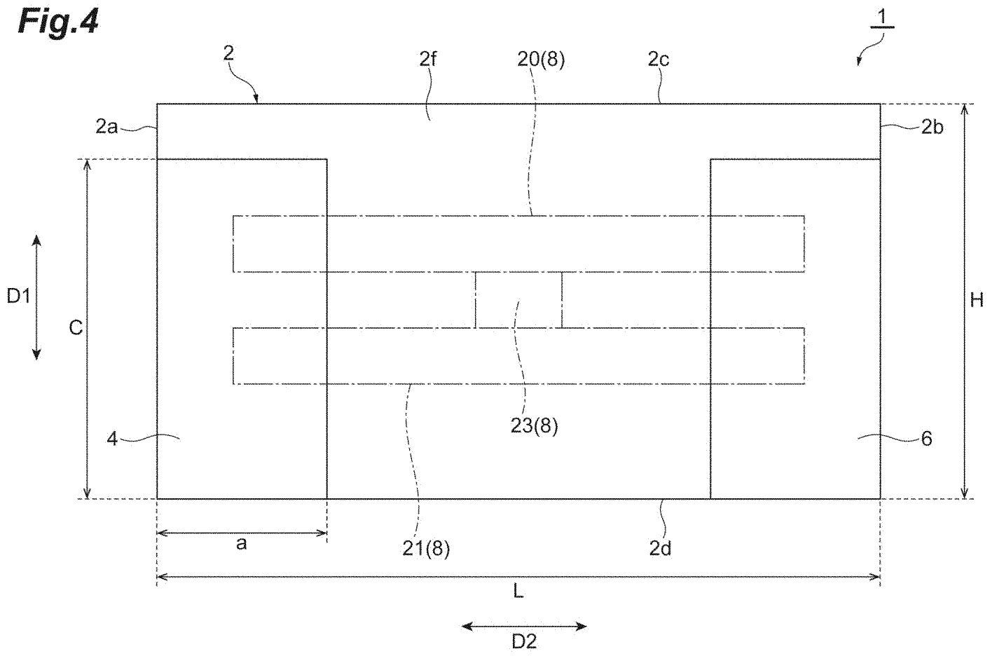

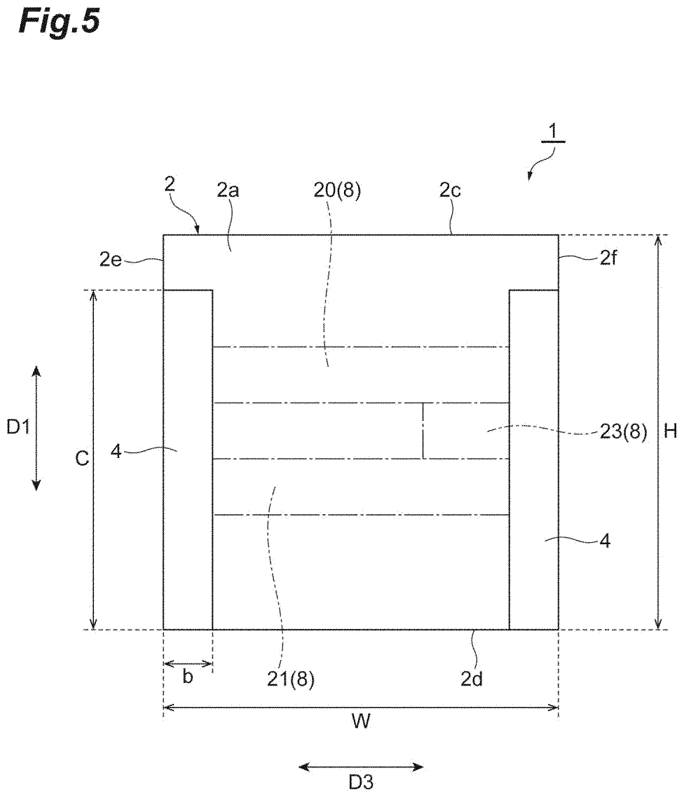

As illustrated in FIG. 3, in each of the terminal electrodes 3, 4, 5, and 6, a dimension a in the second direction D2 is larger than a dimension b in the third direction D3 (a>b). In each of the terminal electrodes 3, 4, 5, and 6, a dimension c in the first direction D1 is larger than the dimension a and the dimension b. As illustrated in FIGS. 4 and 5, the dimension c of each of the terminal electrodes 3, 4, 5, and 6 in the first direction D1 is smaller than the height dimension H of the element body 2 (c<H). In other words, the terminal electrodes 3, 4, 5, and 6 are not exposed on the main surface 2c. The element body 2 is present between the main surface 2c and the main surface 2c side end portion of each of the terminal electrodes 3, 4, 5, and 6.

The multilayer coil component 1 is provided with a coil 8 disposed in the element body 2. A coil axis AX of the coil 8 extends along the first direction D1. The coil 8 has an elliptical outer shape when viewed from the first direction D1.

As illustrated in FIG. 2, the coil 8 has a first coil conductor 20 and a second coil conductor 21. The first coil conductor 20 and the second coil conductor 21 are disposed along the first direction D1 in the order of the first coil conductor 20 and the second coil conductor 21. The first coil conductor 20 and the second coil conductor 21 substantially have a shape in which a part of a loop is interrupted and have one end and the other end. The coil 8 has a connection conductor 23. The connection conductor 23 has a rectangular shape.

The first coil conductor 20 is positioned in the same layer as one electrode layer 10, one electrode layer 11, one electrode layer 12, and one electrode layer 13. The first coil conductor 20 is connected to the electrode layer 13 via a connecting conductor 24. The connecting conductor 24 is positioned in the same layer as the first coil conductor 20. One end of the first coil conductor 20 is connected to the connecting conductor 24. The connecting conductor 24 is connected to the electrode layer 13. The connecting conductor 24 interconnects the first coil conductor 20 and the electrode layer 13. As a result, one end of the coil 8 is electrically connected to the terminal electrode 6. The first coil conductor 20 is separated from the electrode layers 10, 11, and 12 positioned in the same layer. In the present embodiment, the first coil conductor 20, the connecting conductor 24, and the electrode layer 13 are integrally formed.

The connection conductor 23 is disposed in the insulator layer 7 between the first coil conductor 20 and the second coil conductor 21. One electrode layer 10, one electrode layer 11, one electrode layer 12, and one electrode layer 13 are positioned in the insulator layer 7 where the connection conductor 23 is disposed. The connection conductor 23 is separated from the electrode layers 10, 11, 12, and 13 positioned in the same layer. The connection conductor 23 is connected to the other end of the first coil conductor 20 and is connected to one end of the second coil conductor 21. The connection conductor 23 interconnects the first coil conductor 20 and the second coil conductor 21.

The second coil conductor 21 is positioned in the same layer as one electrode layer 10, one electrode layer 11, one electrode layer 12, and one electrode layer 13. The second coil conductor 21 is connected to the electrode layer 10 via a connecting conductor 25. The connecting conductor 25 is positioned in the same layer as the second coil conductor 21. The other end of the second coil conductor 21 is connected to the connecting conductor 25. The connecting conductor 25 is connected to the electrode layer 10. The connecting conductor 25 interconnects the second coil conductor 21 and the electrode layer 10. As a result, the other end of the coil 8 is electrically connected to the terminal electrode 3. The second coil conductor 21 is separated from the electrode layers 11, 12, and 13 positioned in the same layer. In the present embodiment, the second coil conductor 21, the connecting conductor 25, and the electrode layer 10 are integrally formed.

The first coil conductor 20 and the second coil conductor 21 are electrically connected through the connection conductor 23. The first coil conductor 20 and the second coil conductor 21 constitute the coil 8. The coil 8 is electrically connected to the terminal electrode 6 through the connecting conductor 24. The coil 8 is electrically connected to the terminal electrode 3 through the connecting conductor 24.

The first coil conductor 20, the second coil conductor 21, the connection conductor 23, and the connecting conductors 24 and 25 contain a conductive material. The conductive material contains Ag or Pd. The first coil conductor 20, the second coil conductor 21, the connecting conductors 24 and 25, and the connection conductor 23 are configured as a sintered body of conductive paste containing conductive material powder. Examples of the conductive material powder include Ag powder and Pd powder.

In the present embodiment, the first coil conductor 20, the second coil conductor 21, the connection conductor 23, and the connecting conductors 24 and 25 contain the same conductive material as each of the terminal electrodes 3, 4, 5, and 6. The first coil conductor 20, the second coil conductor 21, the connection conductor 23, and the connecting conductors 24 and 25 may contain a conductive material different from the conductive material of each of the terminal electrodes 3, 4, 5, and 6.

The first coil conductor 20, the second coil conductor 21, the connection conductor 23, and the connecting conductors 24 and 25 are provided in a defect portion formed in the insulator layer 7 that corresponds. The first coil conductor 20, the second coil conductor 21, the connection conductor 23, and the connecting conductors 24 and 25 are formed by conductive paste positioned in a defect portion formed in a green sheet being fired. The green sheet and the conductive paste are fired at the same time as described above. Accordingly, the first coil conductor 20, the second coil conductor 21, the connection conductor 23, and the connecting conductors 24 and 25 are obtained from the conductive paste when the insulator layer 7 is obtained from the green sheet.

The defect portion formed in the green sheet is formed by, for example, the following process. First, a green sheet is formed by element paste containing the constituent material of the insulator layer 7 and a photosensitive material being applied onto a base material. The base material is, for example, a PET film. The photosensitive material contained in the element paste may be either a negative photosensitive material or a positive photosensitive material and a known photosensitive material can be used. Next, the green sheet is exposed and developed by a photolithography method by means of a mask corresponding to the defect portion, and then the defect portion is formed in the green sheet on the base material. The green sheet in which the defect portion is formed is an element pattern.

The electrode layers 10, 11, 12, and 13, the first coil conductor 20, the second coil conductor 21, the connection conductor 23, and the connecting conductors 24 and 25 are formed by, for example, the following process.

First, a conductive material layer is formed by conductive paste containing a photosensitive material being applied onto a base material. The photosensitive material contained in the conductive paste may be either a negative photosensitive material or a positive photosensitive material and a known photosensitive material can be used. Next, the conductive material layer is exposed and developed by a photolithography method by means of a mask corresponding to the defect portion, and then a conductor pattern corresponding to the shape of the defect portion is formed on the base material.

The multilayer coil component 1 is obtained by, for example, the following process subsequent to the process described above. A sheet in which the element pattern and the conductor pattern are in the same layer is prepared by the conductor pattern being combined with the defect portion of the element pattern. A predetermined number of the sheets are prepared, a stacked body is obtained by the sheets being stacked, heat treatment is performed on the stacked body, and then a plurality of green chips are obtained from the stacked body. In this process, a green stacked body is cut into chips by means of a cutting machine or the like. As a result, a plurality of green chips having a predetermined size can be obtained. Next, the green chips are fired. The multilayer coil component 1 is obtained as a result of the firing.

As illustrated in FIG. 3, a part of the coil 8 as viewed from the first direction D1 is disposed in each of a first region A1 between the terminal electrode 3 and the terminal electrode 4 and a second region A2 between the terminal electrode 5 and the terminal electrode 6. The first region A1 is formed between the terminal electrode 3 and the terminal electrode 4 disposed so as to face each other in the third direction D3. The second region A2 is formed between the terminal electrode 5 and the terminal electrode 6 disposed so as to face each other in the third direction D3. Specifically, both end portions of the elliptical coil 8 in the long axis direction are disposed in the first region A1 and the second region A2, respectively. In the present embodiment, a part of an inner edge 8a of the coil 8 is positioned in the first region A1 and the second region A2.

As illustrated in FIG. 4, the coil 8 overlaps the terminal electrodes 3, 4, 5, and 6 when viewed from the third direction D3. Specifically, the end surface 2a side end portion of the coil 8 overlaps the terminal electrode 3 and the terminal electrode 4 when viewed from the third direction D3. The end surface 2b side end portion of the coil 8 overlaps the terminal electrode 5 and the terminal electrode 6 when viewed from the third direction D3.

The coil 8 is electrically connected to the terminal electrode 3 and the terminal electrode 6. In the present embodiment, the terminal electrode 4 and the terminal electrode 5 are dummy electrodes. In a case where the multilayer coil component 1 is mounted on a circuit board or the like, the multilayer coil component 1 is disposed on the circuit board such that the terminal electrode 3 and the terminal electrode 6 are mounted on a land electrode connected to wiring.

As described above, in the multilayer coil component 1 according to the present embodiment, the terminal electrodes 3, 4, 5, and 6 are embedded in the element body 2. Accordingly, the terminal electrodes 3, 4, 5, and 6 fit within the outer shape of the element body 2 and do not protrude from the outer surface of the element body 2. Accordingly, the multilayer coil component 1 can be reduced in size. In this configuration, in the multilayer coil component 1, a part of the coil 8 is disposed in the first region A1 and the second region A2. In this manner, in the multilayer coil component 1, a part of the coil 8 is disposed in the region between the pair of terminal electrodes 3 and 4 and the pair of terminal electrodes 5 and 6 disposed so as to face each other. Accordingly, in the multilayer coil component 1, the inner diameter of the coil 8 can be increased, and thus the Q value can be improved. Accordingly, characteristics can be improved in the multilayer coil component 1. In addition, in the multilayer coil component 1, the distance between the coil 8 and the terminal electrodes 3, 4, 5, and 6 can be ensured even in a case where the inner diameter of the coil 8 is increased. Accordingly, in the multilayer coil component 1, the stray capacitance that is generated between the terminal electrodes 3, 4, 5, and 6 and the coil 8 can be reduced. As a result, characteristics can be improved in the multilayer coil component 1.

In the multilayer coil component 1, each of the four terminal electrodes 3, 4, 5, and 6 is disposed over the end surface 2a or the end surface 2b, the main surface 2d, and the side surface 2e or the side surface 2f. When the multilayer coil component 1 is mounted on a circuit board or the like in this configuration, solder is formed at the parts that correspond to the end surface 2a or the end surface 2b, the main surface 2d, and the side surface 2e or the side surface 2f in each of the four terminal electrodes 3, 4, 5, and 6. Accordingly, the multilayer coil component 1 and the circuit board can be firmly fixed. In addition, in the multilayer coil component 1, it can be visually confirmed that the solder is reliably formed since the solder is formed at the parts that correspond to the end surface 2a or the end surface 2b and the side surface 2e or the side surface 2f in each of the four terminal electrodes 3, 4, 5, and 6.

In the multilayer coil component 1 according to the present embodiment, the length dimension L of the element body 2 is larger than the width dimension W of the element body 2. A part of the coil 8 is disposed in the first region A1 and the second region A2. In this configuration, the inner diameter of the coil 8 can be maximized in the coil 8 disposed in the element body 2 having a rectangular parallelepiped shape. Accordingly, characteristics can be further improved in the multilayer coil component 1.

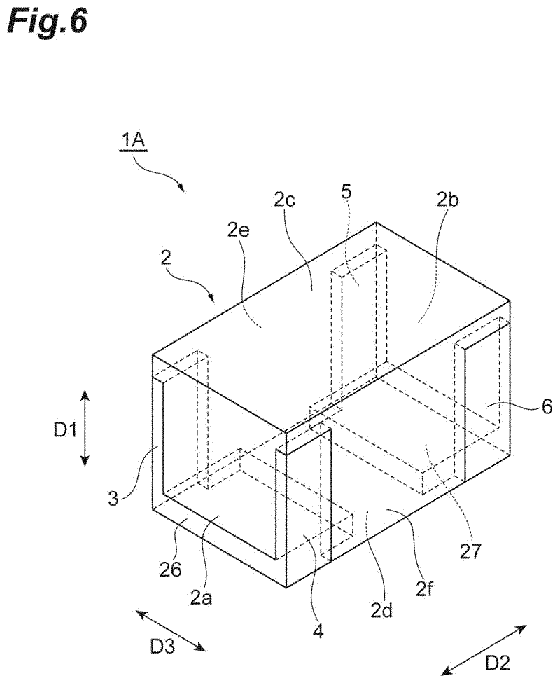

In the multilayer coil component 1 according to the present embodiment, the dimension a in the second direction D2 is larger than the dimension b in the third direction D3 in each of the four terminal electrodes 3, 4, 5, and 6. In this configuration, the first region A1 and the second region A2 can be enlarged in the third direction D3. Accordingly, in the multilayer coil component 1, it is possible to ensure the distance between the coil 8 and the terminal electrodes 3, 4, 5, and 6 while increasing the inner diameter of the coil 8. As a result, characteristics can be improved in the multilayer coil component 1.

[Second Embodiment] Next, a second embodiment will be described. As illustrated in FIG. 6, a multilayer coil component 1A is provided with the element body 2 having a rectangular parallelepiped shape, the terminal electrodes 3, 4, 5, and 6, and connecting electrodes 26 and 27.

The connecting electrode 26 interconnects the terminal electrode 3 and the terminal electrode 4. The connecting electrode 26 is disposed on the main surface 2d. The connecting electrode 26 has a rectangular shape when viewed from the first direction D1. The connecting electrode 26 is embedded in the element body 2. The connecting electrode 26 is disposed over the end surface 2a and the main surface 2d. In the second direction D2, the connecting electrode 26 protrudes to the end surface 2b side beyond the terminal electrodes 3 and 4. The surface of the connecting electrode 26 is substantially flush with the end surface 2a and the main surface 2d.

The connecting electrode 27 interconnects the terminal electrode 5 and the terminal electrode 6. The connecting electrode 27 is disposed on the main surface 2d. The connecting electrode 27 has a rectangular shape when viewed from the first direction D1. The connecting electrode 27 is embedded in the element body 2. The connecting electrode 27 is disposed over the end surface 2b and the main surface 2d. In the second direction D2, the connecting electrode 27 protrudes to the end surface 2a side beyond the terminal electrodes 5 and 6. The surface of the connecting electrode 27 is substantially flush with the end surface 2b and the main surface 2d.

The connecting electrodes 26 and 27 contain a conductive material. The conductive material contains, for example, Ag or Pd. The connecting electrodes 26 and 27 are configured as a sintered body of conductive paste containing conductive material powder. Examples of the conductive material powder include Ag powder and Pd powder. A plating layer may be formed on the surfaces of the connecting electrodes 26 and 27. The plating layer is formed by, for example, electroplating or electroless plating. The plating layer contains, for example, Ni, Sn, or Au.

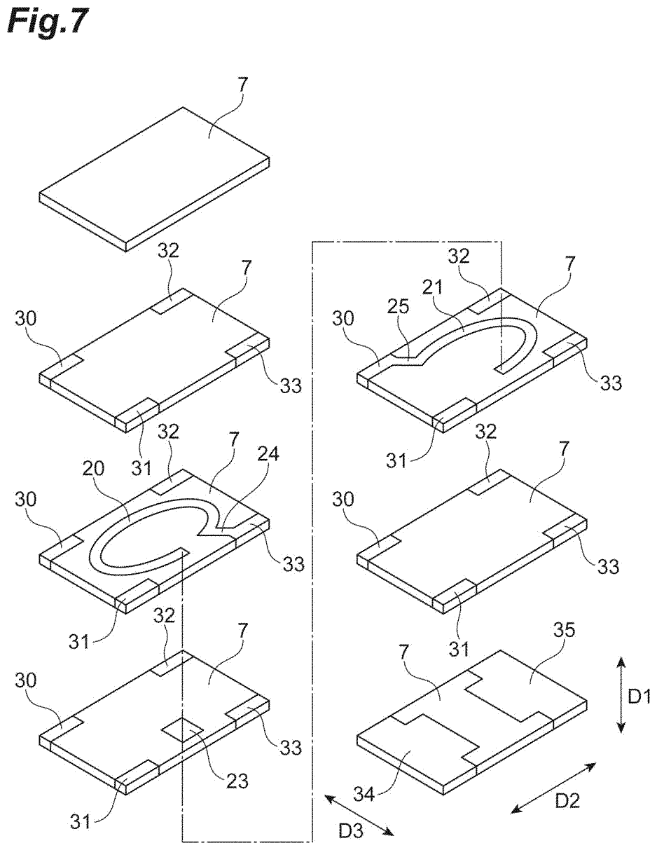

As illustrated in FIG. 7, the terminal electrode 3 is configured by a plurality of electrode layers 30 and one electrode layer 34 being stacked. In the present embodiment, the number of the electrode layers 30 is “5”. The terminal electrode 4 is configured by a plurality of electrode layers 31 and one electrode layer 34 being stacked. In the present embodiment, the number of the electrode layers 31 is “5”. The terminal electrode 5 is configured by a plurality of electrode layers 32 and one electrode layer 35 being stacked. In the present embodiment, the number of the electrode layers 32 is “5”. The terminal electrode 6 is configured by a plurality of electrode layers 33 and one electrode layer 35 being stacked. In the present embodiment, the number of the electrode layers 33 is “5”. The electrode layer 34 constitutes the connecting electrode 26. The electrode layer 35 constitutes the connecting electrode 27.

In the multilayer coil component 1A according to the present embodiment, a part of the coil 8 is disposed in the first region A1 and the second region A2. In this manner, in the multilayer coil component 1A, a part of the coil 8 is disposed in the region between the pair of terminal electrodes 3 and 4 and the pair of terminal electrodes 5 and 6 disposed so as to face each other. Accordingly, in the multilayer coil component 1A, the inner diameter of the coil 8 can be increased, and thus the Q value can be improved. Accordingly, characteristics can be improved in the multilayer coil component 1A. In addition, in the multilayer coil component 1A, the distance between the coil 8 and the terminal electrodes 3, 4, 5, and 6 can be ensured even in a case where the inner diameter of the coil 8 is increased. Accordingly, in the multilayer coil component 1A, the stray capacitance that is generated between the terminal electrodes 3, 4, 5, and 6 and the coil 8 can be reduced. As a result, characteristics can be improved in the multilayer coil component 1A.

The multilayer coil component 1A according to the present embodiment is provided with the connecting electrode 26 interconnecting the terminal electrode 3 and the terminal electrode 4 and the connecting electrode 27 interconnecting the terminal electrode 5 and the terminal electrode 6. The connecting electrodes 26 and 27 are disposed on the main surface 2d, which is a mounting surface. When the multilayer coil component 1A is mounted on a circuit board or the like in this configuration, the multilayer coil component 1A and the circuit board can be more firmly fixed.

Although embodiments of the present invention have been described above, the present invention is not necessarily limited to the embodiments described above and various modifications can be made within the scope of the present invention.

Described as an example in the embodiment is a form in which the coil 8 is connected to the terminal electrode 3 and the terminal electrode 6. However, the coil 8 may also be connected to the terminal electrode 4 and the terminal electrode 5.

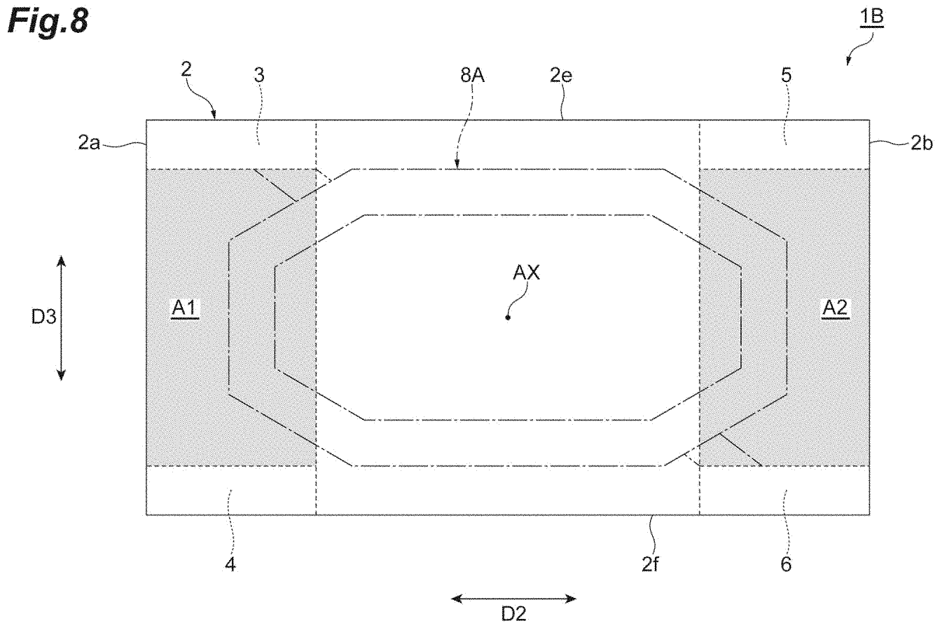

Described as an example in the embodiment is a form in which the coil 8 has an elliptical shape when viewed from the first direction D1. However, the shape of the coil 8 is not limited thereto. For example, as illustrated in FIG. 8, a coil 8A may have a polygonal shape in a multilayer coil component 1B.

Described as an example in the embodiments is a form in which a part of the coils 8 and 8A is disposed in the first region A1 and the second region A2. However, a part of the coils 8 and 8A may be disposed in a third region between the terminal electrode 3 and the terminal electrode 5 and a fourth region between the terminal electrode 4 and the terminal electrode 6. In addition, a part of the coils 8 and 8A may be disposed in the first region A1, the second region A2, the third region, and the fourth region.

Described as an example in the embodiment is a form in which the dimension c of the terminal electrodes 3, 4, 5, and 6 is smaller than the height dimension H of the element body 2. However, the dimension c of the terminal electrodes 3, 4, 5, and 6 may be equal to the height dimension H of the element body 2. The terminal electrodes 3, 4, 5, and 6 may be disposed from the main surface 2c to the main surface 2d.

Described as an example in the embodiment is a form in which the coil 8 has the first coil conductor 20, the second coil conductor 21, the connection conductor 23, and the connecting conductors 24 and 25. However, each conductor constituting the coil 8 is not limited in number to the value described above. The same applies to the coil 8A.

Described as an example in the embodiment is a form in which a magnetic material or a nonmagnetic material constitutes the insulator layer 7. Alternatively, a resin material or the like may constitute the insulator layer 7. In this configuration, the material constituting each conductor of the coils 8 and 8A may be Cu or the like.

What is claimed is:

1. A multilayer coil component comprising:
an element body including a pair of end surfaces facing each other, a pair of main surfaces facing each other, and a pair of side surfaces facing each other, one of the main surfaces being a mounting surface;
a coil disposed in the element body and having a coil axis extending along a facing direction of the pair of main surfaces; and
four terminal electrodes embedded in the element body and respectively disposed in four corner portions of the element body respectively formed by the pair of end surfaces and the pair of side surfaces, wherein
each of the four terminal electrodes is disposed over at least the end surface, the mounting surface, and the side surface, and
a part of the coil as viewed from the facing direction of the pair of main surfaces is disposed in at least one of first and second regions formed between the pair of terminal electrodes disposed so as to face each other in a facing direction of the pair of side surfaces and third and fourth regions formed between the pair of terminal electrodes disposed so as to face each other in a facing direction of the pair of end surfaces.

2. The multilayer coil component according to claim 1, wherein
a first dimension of the element body in the facing direction of the pair of end surfaces is larger than a second dimension of the element body in the facing direction of the pair of side surfaces, and
a part of the coil is disposed in at least the first region and the second region.

3. The multilayer coil component according to claim 2, wherein a dimension in the facing direction of the pair of end surfaces is larger than a dimension in the facing direction of the pair of side surfaces in each of the four terminal electrodes.

4. The multilayer coil component according to claim 1, further comprising a connecting electrode embedded in the element body, interconnecting the pair of terminal electrodes disposed so as to face each other in the facing direction of the pair of side surfaces, and disposed on the mounting surface.
